(19) United States
(12) Patent Application Publication
(10) Pub. No.: US 2007/0016640 A1
(43) Pub. Date: Jan. 18, 2007

(54) Contacting method for inter-person communication

(76) Inventors: Vincent Auvray, Caen (FR); Olivier Briand, Caen (FR); Anthony Dauguet, Saint Pierre du Fresne (FR)

Correspondence Address: FISH & RICHARDSON, P.C., PO BOX 1022, MINNEAPOLIS, MN, 55440-1022, US

(21) Appl. No.: 11/485,614

(22) Filed: Jul. 12, 2006

(30) Foreign Application Priority Data
Jul. 12, 2005 (FR) 0507478

(51) Int. Cl. G06F 15/16

(52) U.S. Cl. 709/205

(57) ABSTRACT

The invention concerns a method for inter-person contacting allowing a communication to be set up between at least two users (client1, client2) at the request of one thereof, by using a presence status of each user, characterized in that said method comprises a contact request step (E1) in which a user parameters at least one contacting action between said user and at least one other user, and a step (E6) for automatic activation of said contacting action in accordance with the parameters set by said user when the presence status associated with the users concerned by said contacting action allows contacting to be made.

The present invention generally relates to the area of telecommunications. It relates more particularly to a method for inter-person contact allowing a communication to be set up between at least two users at the request of one thereof, by making use of a presence status of each user as provided by a presence management system, typically the presence management system used in instant messaging services.

Amongst the services used in a telecommunications network such as the Internet, instant messaging services enable direct dialogue between users, typically by means of written messages sent and received synchronously.

The instant messaging service is also adapted to list a group of users able to be placed in communication via instant messaging. User identification data is listed for this purpose in an entity called a <<Buddy List>> particular to each user of the system. The server holds a BL database of all user contact lists.

An instant messaging service is generally associated with a presence management system, which advantageously provides users with the opportunity to consult the list of contacts with which they are simultaneously on line so that they may make immediate communication therewith. With the presence management system, it is therefore possible at a given time to determine whether a user is or is not present on the instant messaging service, i.e. is or is not available to take part in a discussion with the members of the user's contact list.

The growing success of instant messaging services has led to the providing of additional back-up functions so as to offer users a more developed range of inter-person contacting services rather than mere instant messaging. The instant messaging system is therefore able to cooperate with one or more multimedia contacting systems, S-MR, making it possible to set up a communication between several persons which may be of audio, audiovisual or text type.

These different contacting services may advantageously be interfaced with the presence management function offered by the instant messaging service. Communication contact is therefore facilitated since it is possible to use the presence management data such as provided by the instant messaging system. Therefore, before setting up a telephone communication for example with a user in the contact list, it is possible to know the availability of the contact person before attempting to enter in communication with said person.

With the architecture of an instant messaging service such as described, it is therefore possible to couple a telephony, videophony or other communication system to the presence management system of an instant messaging client. In this way, the connection can be managed via the chosen communication medium in relation to the availability status of the persons to be placed in contact.

However, while the call initiator can effectively determine the presence status of its contact person before attempting to set up a communication with such person, if the latter is unavailable the caller has no information on the period of unavailability and must therefore renew connection attempts until the presence status of the contact person is shown to be available.

The present invention sets out to overcome this shortcoming by providing an inter-person contacting method which releases users from having to verify the availability of their contact person or persons, enabling them to parameter contacting actions even when the contact persons are not yet available, and to define the conditions under which the contacting action is to be performed.

With this objective in view, the subject of the invention is a method for inter-person contacting allowing communication between at least two users at the request of one thereof, using a presence status of each user, characterized in that said method comprises a contact request step during which a user parameters at least one contacting action between said user and at least one other user, and an automatic activation step of said contacting action, in accordance with the parameters set by the user, when the presence status associated with the users concerned by said contacting action allows the contacting to be made.

Preferably the contact request step, for each contacting action, consists of defining the users concerned by said contacting action and a communication mode between them.

Preferably, the contact request step, for each contacting action, consists of defining a time period during which said contacting action can be automatically activated.

Advantageously the method comprises a polling step, at regular intervals, on the presence status of the users concerned by said action.

The invention also concerns a device able to deliver communication services to a plurality of users each having a client entity, by using the presence status of each user provided by a presence management system, said communication service device being characterized in that it comprises means for receiving contacting actions between users, parametered by at least one user by means of his/her client entity connected to said communication service device, and means for managing each contacting action received by said communication service device, in accordance with the parameters set by the user, when the presence status associated with the users concerned by said contacting action allows the contact to be made.

Advantageously the means for managing contacting actions received by said device comprise means for polling the presence management system at regular intervals so as to obtain the presence status of the users concerned and to automatically trigger their connection, in accordance with set parameters, when the presence statuses received allow contacting to be made.

Preferably, the contacting parameters set by the user comprise the identification of the users concerned by the requested contact and the communication mode to be set up between them.

According to one embodiment, the communication service device comprises an instant messaging server able to deliver instant messaging services to said plurality of users, each having an instant messaging client entity for the connection and exchange of messages with said server.

According to one variant, said instant messaging server cooperates with a multimedia contacting system comprising means for setting up a communication of telephony and/or videophony type.

The invention further concerns a client entity able to communicate with a communication service device designed to place in contact a plurality of users each having a client entity, by using the presence status of each user as provided by a presence management system, said client entity being characterized in that it comprises means for parametering at least one contacting action with other client entities, and means for requesting automatic activation of said contacting action by said device, in accordance with the parameters set by the user, when the presence status associated with the users concerned by said contacting action allows the contact to be made.

The invention also concerns a computer programme intended to be implemented on a device able to deliver communication services to a plurality of users each having a client entity, by utilizing a presence status of each user as delivered by a presence management system, said programme being characterized in that it comprises software instructions to process the receiving, by said communication service device, of contacting actions between users that are parametered by at least one user by means of said user's client entity connected to said communication service device, and software instructions to automatically activate each contacting action received by said communication service device, in accordance with the parameters set by the user, as soon as the presence status associated with the users concerned by said contacting action allows contacting to be made.

The invention also concerns a computer programme intended to be implemented on a client entity able to communicate with a communication service device intended to place in contact a plurality of users each having a client entity, by utilizing a presence status of each user as provided by a presence management system, said programme being characterized in that it comprises software instructions to conduct the parametering of at least one contacting action with other client entities, and instructions to request the automatic activation of said contacting action by said device, in accordance with the parameters set by the user, when the presence status associated with the users concerned by said contacting action allows the contact to be made.

Finally, the invention concerns a method for setting up a communication mode between at least a first user and at least a second user, said users each having a client entity able to set up a first communication mode via a first telecommunication system, said system comprising means with which to determine a presence status of said users with said system, characterized in that said method comprises:

a parametering step, during which said first user parameters at least a second communication mode between said first user and said second user, said system cooperating with a second telecommunication system to set up said second communication mode, and

an automatic activation step of said second communication mode, in relation to said presence status,

An example of the first communication mode is the exchange of messages via an instant messaging system.

An example of the second communication mode is a telephone connection.

Other characteristics and advantages of the present invention will become clearer on reading the following description given as an illustrative, non-restrictive example with reference to the single appended FIGURE:

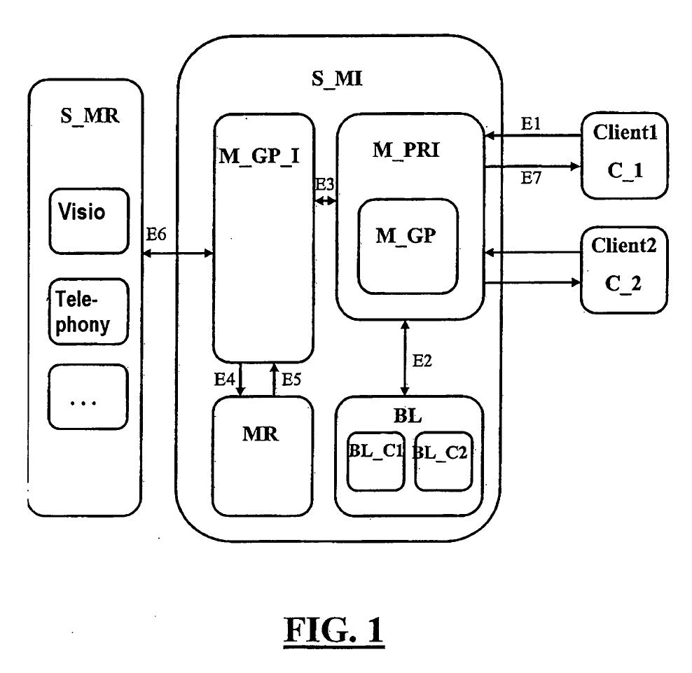

FIG. 1, which illustrates the functional architecture of an inter-person contacting system according to the present invention.

The following description more particularly refers to a communication service device based on an instant messaging server preferably coupled to a multimedia contacting system. However, other communication service devices equipped with presence management means could be contemplated without departing from the scope of the present invention. Therefore the present invention could, for example, apply to a local network having a terminal such as Bluetooth, Wi-Fi, etc. Short range communication systems of Bluetooth or Wi-Fi type can be adapted to detect user terminal input/output within the area covered. In this context, presence management therefore entails detecting the presence of a user terminal in the network area covered.

With reference to FIG. 1, the embodiment of the invention is more particularly based on a device, S_MI, able to deliver communication services of instant messaging service type. According to one variant of the invention, this S_MI device of instant messaging server type cooperates with a multimedia contacting system S_MR. In this way, the different contacting services offered may advantageously be interfaced with the presence management function M_GP integrated in a main instant messaging module M_PRI of the server S_MI. For this purpose, an interface module M_GP_I is provided between the main instant messaging module M_PRI and the contacting module or modules S_MR.

Therefore, since these previously cited elements are coupled together, with said system it is possible to manage inter-person multimedia contacting e.g. of telephony and/or videophony type, but also contacting via instant messaging in accordance with the availability status of the called person and of the caller.

According to the example in FIG. 1 a group of users Client1 and Client2 each having suitable software and equipment means, which shall hereunder be called client entity C_1 and client entity client C-2, may set up a communication between them through the network via connection to the S_MI instant messaging server. The database BL stores the list of contacts BL-C1 of user Client1 with the identification data of user Client2, and the list of contacts BL-C2 of user Client2 with the identification data of user Client1.

The Client1 user, wishing to communicate with one of the contacts entered into its list of contacts, in this case Client2, may therefore at any time send a communication request to the messaging service. Said request will be processed by the main instant messaging module M_PRI, enabling presence management.

Typically, the requested contacting is intended to be set up immediately if the called user is available at the time the caller requests connection, this information on availability being obtained from the presence statuses of the different users on the caller's contact list, which are displayed on the caller's client entity.

The invention also enables users of the system to configure a list of contacting actions with the other users, so that these actions, once configured, may be automatically initiated under user-determined conditions, when the presence status associated with the users concerned by these contacting actions allows the contact to be made.

Said functioning mode may, in particular, enable a user to determine that a connection will be set up later, under conditions which may be determined, as soon as the presence status of the called user changes from an “unavailable” status to an “available” status after the call initiator has requested contact, the call initiator also having to be in available status for said contacting.

Several contact requests may therefore be made and configured by a calling user, enabling the latter to manage various contacting actions flexibly and efficiently. This management may advantageously be conducted via a particular interface of the user's client entity, presenting said user with the list of contacting actions that have been configured, made, and in progress. The contacting actions defined by the user may also be added, deleted or modified via the interface.

The configuration parameters of the contacting actions may relate to the identification of the users concerned by the contacting action, and to the mode of communication between the users which may be chosen from among instant messaging service or, according to variant, from among the contacting modes offered by the multimedia contacting system S_MR cooperating with the instant messaging server.

The connecting modes between users proposed by the multimedia connecting system S_MR comprise, for example, a connection mode by telephony, or a connection mode via videophony.

The configuration parameters of the contacting actions may also, for each contacting action recorded by a user, relate to a defined time interval during which the contacting action may be automatically activated when user statuses allow such connection. The user can therefore parameter the time on and after which activation of connection is possible, and the time on and after which activation of the contacting action is no longer possible.

To implement this functioning mode, the messaging server S_MI integrates a module MR for managing contacting actions recorded by the system's users. This module is intended to cooperate with the interface module M_GP_I provided between the main messaging module M_PRI and the contacting system S_MR.

This MR module therefore provides the instant messaging server with means for recording contacting actions between users, which are directly parametered on the server by the users by means of their client entity connected to the server, and with means for managing these contacting actions recorded on the server, in accordance with the parameters set by the users, in relation to the presence status associated with the users concerned by these contacting actions. To do so, for each contacting action configured and recorded on the server, the management module MR is designed to poll the presence management module M_GP of the instant messaging server at regular intervals, so that it can automatically trigger the connection under the contacting conditions parametered by the user as soon as the presence statuses obtained in reply to the polling request by the presence management module allow the connection to be made, typically when the presence status of the calling and called users are shown to be available.

The configuration of an action within the management module MR of the instant messaging server S_MI is therefore made via an instant messaging client entity, directly on the instant messaging server, and is performed as follows:

Client entity C_1 addresses the instant messaging server to define a contacting action in its contact list. To do so, the user may use an <<add>> function in an instant messaging client menu dedicated to the management of the client's contacts with other clients.

This contacting action may for example concern a request for contacting client entity C_2. With reference to FIG. 1, client entity C_1, at step E1, sends a request to configure a contacting action to the instant messaging server. Generally, said request chiefly contains the user or users to be called, the calling user, the action (contacting) and the communication mode to be used between the users, telephony for example.

Here is an example of the implementation of a request of this type, using the XMPP instant messaging protocol (for <<eXtensible Messaging and Presence Protocol>>), made by client C_1 to be placed in contact with client C_2 in telephone mode: <xmpp sender=<<C_1>>, recipient=<<C_2>>, action=<<contacting>>, mode=<<telephone>>, msg=<< >>/>.

Other parameters could also be set by the user, relating in particular to the time period during which the contacting action may automatically be activated when the availability status of the recipient so permits.

This request will be taken in charge by the main instant messaging module M_PRI which will first verify, at step E2, that the user of client C_1 is effectively on the contact list of the user of client C_2, and reciprocally. If this is the case, the main module M_PRI forwards the request, at step E3, to the interface module M_GP_I between the main instant messaging module, the management module and the contacting system, for transmission at step E4 to the management module MR. The management module MR then adds the action so parametered to the list of actions of the user of client entity C_1.

Subsequently, at step E5, the management module MR at regular intervals and via the interface module M_GP_I with the main messaging module M_PRI, polls the presence management module M_GP of the instant messaging server to know the availability status associated with the users concerned, namely the calling user of client entity C_1 and the called user of client entity C_2. For as long as the calling user and/or called user are defined as being unavailable, this phase is continued.

When all the conditions of the contacting request parametered by the user of client C_1 are met, i.e. the caller and the called user are available, optionally within the time period indicated for automatic activation of the action, then the interface module M_GP_I, at step E6, requests clients C_1 and C_2 to be automatically placed in contact. To do so, it communicates to the contacting system S_MR the contacting data required, in particular the telephone numbers to connect the users of clients C_1 and C_2, since a telephone connection has been requested. This data required by the system to set up contact is stored in the user profile on the instant messaging server at the time the user accounts are created.

Once contacting has successfully been made, an acknowledgement is returned by the contacting system to the interface module M_GP_I which then changes the corresponding action from an <<in progress>> status to a <<completed>> status in the management module MR managing contacting actions. This updated status is transmitted, at step E7, to client C_1. The particular interface of client entity C_1 comprises means for indicating to the user the list of contacting actions said user has configured on the server with their <<completed>> and <<in progress>> status, and the details of these actions corresponding to the different parameters entered by the user relating for example to the contacting mode, to the time on and after which activation of the contacting action possible, to the time on and after which the contacting action is no longer possible . . . .

1. Inter-person contacting method allowing a communication to be set up between at least two users (client1, client2) at the request of one thereof, by using a presence status of each user, characterized in that said method comprises a contact request step (E1) during which a user parameters at least one contacting action between said user and at least one other user, and a step (E6) for automatic activation of said contacting action, in accordance with the parameters set by said user, when the presence status associated with the users concerned by said contacting action allows contacting to be made.

2. Method as in claim 1, characterized in that the contact request step (E1), for each contacting action, consists of determining the users concerned by said contacting action and a communication mode between them.

3. Method as in claim 1 or 2, characterized in that the contact request step (E1), for each contacting action, consists of defining a time period during which said contacting action can be automatically activated.

4. Method as in any of the preceding claims, characterized in that the method comprises a polling step (E5) to poll, at regular intervals, the presence status of the users concerned by said action.

5. Device (S_MI) able to deliver communication services to a plurality of users (Client1, Client2), each having a client entity (C_1, C_2), by using a presence status of each user as delivered by a presence management system (M_GP), said communication service device (S_MI) being characterized in that it comprises means (MR) for receiving contacting actions between users, parametered by at least one user via its client entity connected to said communication service device, and means (MR) for managing each contacting action received by said communication service device, in accordance with the parameters set by the user, when the presence status associated with the users concerned by said contacting action allows contacting to be made.

6. Device as in claim 5, characterized in that the means (MR) for managing contacting actions, received by said device, comprise means for polling at regular intervals the presence management system (M_GP) so as to obtain the presence statuses of the users concerned and to trigger connection automatically in accordance with set parameters as soon as the presence statuses obtained allow a connection to be set up.

7. Device as in claim 5 or 6, characterized in that the contacting parameters set by the user comprise the identification of the users concerned by the connection and the mode of communication to be set up between them.

8. Device as in any of claims 5 to 7, characterized in that it comprises an instant messaging server (S_MI) able to deliver instant messaging services to said plurality of users (Client1, Client2) each having an instant messaging client entity (C_1, C_2) for the connection and exchange of messages with said server.

9. Device as in claim 8, characterized in that said instant messaging server (S_MI) cooperates with a multimedia contacting system (S_MR) comprising means for setting up a communication of telephony and/or videophony type.

10. Client entity (C_1, C_2) able to communicate with a communication service device (S_MI) intended to place in contact a plurality of users each having a client entity, by using a presence status of each user as provided by a presence management system (M_GP), said client entity being characterized in that it comprises means for parametering at least one contacting action with other client entities, and means for requesting the automatic activation of said contacting action by said device (S_MI) in accordance with he parameters set by the user, as soon as the presence statuses associated with the users concerned by said contacting action allow contacting to be made.

11. Computer programme intended to be implemented on a device (S_MI) able to deliver communication services to a plurality of users (Client1, Client 2) each having a client entity (C_1, C_2) by using a presence status of each user as delivered by a presence management system (M_GP), said programme being characterized in that it comprises software instructions to process receipt by said communication service device of contacting actions between users, parametered by at least one user by means of its client entity connected to said communication service device, and software instructions to activate automatically each contacting action received by said communication service device, in accordance with the parameters set by the user, as soon as the presence status associated with the users concerned by said contacting action allows contacting to be made.

12. Computer programme intended to be implemented on a client entity (C_1, C_2) able to communicate with a communication service device (S_MI) intended to place in contact a plurality of users each having a client entity by using a presence status of each user as provided by a presence management system (M-GP), said programme being characterized in that it comprises software instructions to conduct parametering of at least one contacting action with other client entities, and instructions for requesting automatic activation of said contacting action by said device (S_MI) in accordance with the parameters set by the user, when the presence status associated with the users concerned by said contacting action allows contacting to be made.

13. Method for setting up a communication mode between at least a first user (client1) and at least a second user (client2), said users having a client entity (C_1, C_2) able to set up a first communication mode via a first telecommunication system (S_MI), said system comprising means (M_GP) making it possible to determine a presence status of said users (client1, client2) with said system (S_MI), characterized in that said method comprises:
a parametering step (E1) in which said first user parameters at least a second communication mode between said first user and said second user, said system (S_MI) cooperating with a second telecommunication system (S_MR) to set up said second communication mode, and
a step (E6) for automatic activation of said second communication mode in relation to said presence status.
